(19) United States
(12) Patent Application Publication
(10) Pub. No.: US 2019/0220330 A1
(43) Pub. Date: Jul. 18, 2019

(54) System and Method of Identifying and Locating Firearms

(71) Applicant: Daniel Scott Tyhanic, II, Trout Run (US)

(72) Inventor: Daniel Scott Tyhanic, II, Trout Run (US)

(21) Appl. No.: 16/247,564

(22) Filed: Jan. 14, 2019

Related U.S. Application Data
(60) Provisional application No. 62/617,019, filed on Jan. 12, 2018.

(51) Int. Cl. G06F 9/54; F41A 35/00; G06F 16/909; G06F 16/9035

(52) U.S. Cl. CPC G06F 9/542; F41A 35/00; G06Q 50/265; G06F 16/9035; G06F 16/909

(57) ABSTRACT

A system and a method of identifying and locating a firearm provides location information for firearms relative to a user. Components are integrated into the firearm that enable location data to emit from the firearm for subsequent collection and distribution by any of several remote servers. A plurality of user accounts is managed by the remote server, wherein each user account is associated with a corresponding personal computing (PC) device. The current firearm location for each firearm profile and the current user location are continuously relayed to the remote server. The two locations are compared to identify at least one in-danger user account from the plurality of user accounts. Upon identification, a potentially-hostile situation alert is relayed from the remote server to the corresponding PC device of the in-danger user account.

The current application claims a priority to the U.S. Provisional Patent application Ser. No. 62/617,019 filed on Jan. 12, 2018. The current application is filed on Jan. 14, 2019 while Jan. 12, 2019 was on a weekend.

### FIELD OF THE INVENTION

The present invention generally relates to a firearm equipped with wireless monitoring devices. More specifically, the present invention is a firearm tracking device that collects location data for firearms. The present invention further relates to a mechanism for receiving notifications as to the proximity of firearms relative to a personal computing device.

### BACKGROUND OF THE INVENTION

Gun safety and policy has evolved into an omnipresent issue in the world. Debates raging between various political parties and groups have left the firearm industry in a delicate situation, not wanting to encourage or enable harmful activity and not wanting to restrict or limit their clients' enjoyment of their products. Many firearm manufacturers have resorted to adding security measures, including fingerprint scanners, proximity detection, and other biometric systems to their products. This increases firearm cost in order to ensure that only an authorized user can fire the gun and simultaneously fails to properly address the major issue of gun violence. Such technologies only make it harder to fire a gun quickly in a time of need, leading to more dangerous situations.

However, the above efforts do not indicate that the problem of gun violence cannot be solved through additional technological efforts. Gun abuse, or the act of utilizing a gun for violence against another human, would be reduced if the locations of all firearms were known to relevant parties. Particularly, issues stemming from misidentification of guns by police officers would be addressed easily. Police officers currently have to be in the unenviable position of making split-second decisions that affect the lives of everybody involved in an altercation and being held responsible for the repercussions of a mistake. It is therefore an objective of the present invention to introduce a system that increases gun safety but does not inhibit gun use. Further desirable is a device which provides information regarding location or distance of a user to a firearm.

The present invention addresses these issues. The present invention records data relating to the geospatial location in which a firearm is located. This allows law enforcement officials and other parties to review recorded data and make better-informed decisions. The present invention provides notifications when a firearm is within a given range of a user's device. A series of electrical components, including a global positioning system (GPS) module and a power supply, combine to send relevant location data from the firearm. That data is collected in remote servers, where it is prepared for automatic distribution to users who are approaching firearms.

### BRIEF DESCRIPTION OF THE DRAWINGS

FIG. 1 is a block diagram illustrating the system of the present invention.

FIG. 2A is a flowchart illustrating the overall process for the method of the present invention.

FIG. 2B is a continuation of the flowchart in FIG. 2A.

FIG. 3 is a flowchart illustrating the subprocess of tracking a current firearm location with a global positioning system (GPS) module.

FIG. 4 is a flowchart illustrating the subprocess of tracking a current user location with a GPS module.

FIG. 5 is a flowchart illustrating the subprocess of appending a current firearm location and a current user location into a potentially-hostile situation alert.

FIG. 6 is a flowchart illustrating the subprocess of appending a danger distance into a potentially-hostile situation alert.

FIG. 7 is flowchart illustrating the subprocess of appending a registered owner information into a potentially-hostile situation alert.

FIG. 8 is flowchart illustrating the subprocess of appending a firearm identification number into a potentially-hostile situation alert.

FIG. 9 is flowchart illustrating the subprocess of searching for a specific firearm profile.

FIG. 10 is flowchart illustrating the subprocess of using a call center.

### DETAILED DESCRIPTION OF THE INVENTION

All illustrations of the drawings are for the purpose of describing selected versions of the present invention and are not intended to limit the scope of the present invention.

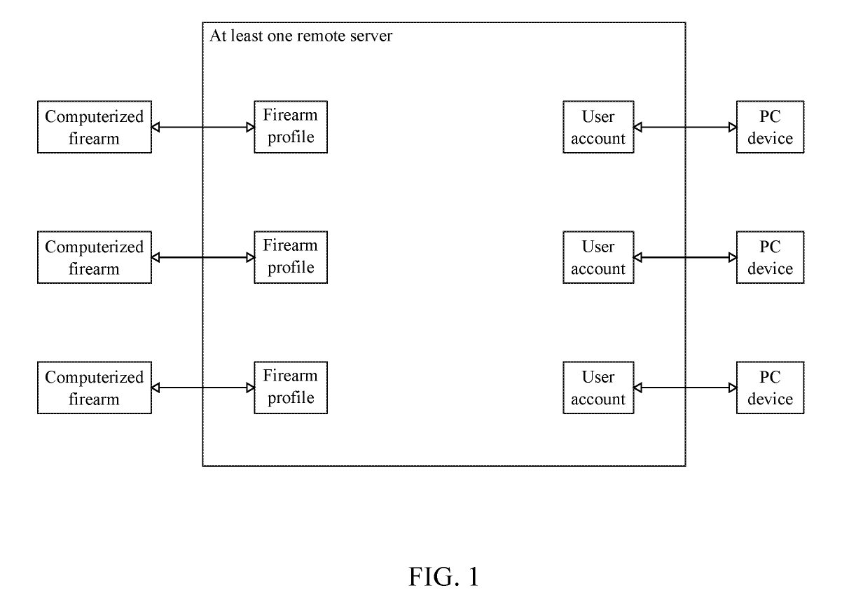

The present invention is a system and a method of identifying and locating a firearm that provides location information for firearms relative to a user. The present invention accomplishes this by integrating components into the firearm that enable location data to emit from the firearm for subsequent collection and distribution by several remote servers. As can be seen in FIG. 1, the system of the present invention includes a plurality of firearm profiles managed by at least one remote server (Step A). The plurality of firearm profiles allows the remote server to identify each firearm that the present invention is monitoring and includes descriptive data on each firearm. The at least one remote server is a node on a network that allows for capture, organization, and transmission of data from the plurality of firearm profiles. Each of the firearm profiles is associated to a corresponding computerized firearm. A corresponding computerized firearm is a firearm that is equipped with system components that allow for transmission of location signals to a remote server. This arrangement enables communication from each firearm to a remote server, which enables subsequent storage and analysis of firearm profile information by the remote server. In order to distribute the information collected by the servers, users may interact with the present invention through a plurality of user accounts that are managed by the remote server. Each user account is associated with a corresponding personal computing (PC) device, as seen in Step B. The corresponding PC device can be, but is not limited to, a laptop, a desktop, a smartphone, and a tablet computing device. Each user account records location data for the given user account. In this way, a given PC device connects a given user account to a remote server. The remote server then has both location data from each of the plurality of firearm profiles, as well as location information from a user account, and can subsequently compare and analyze the two location datasets.

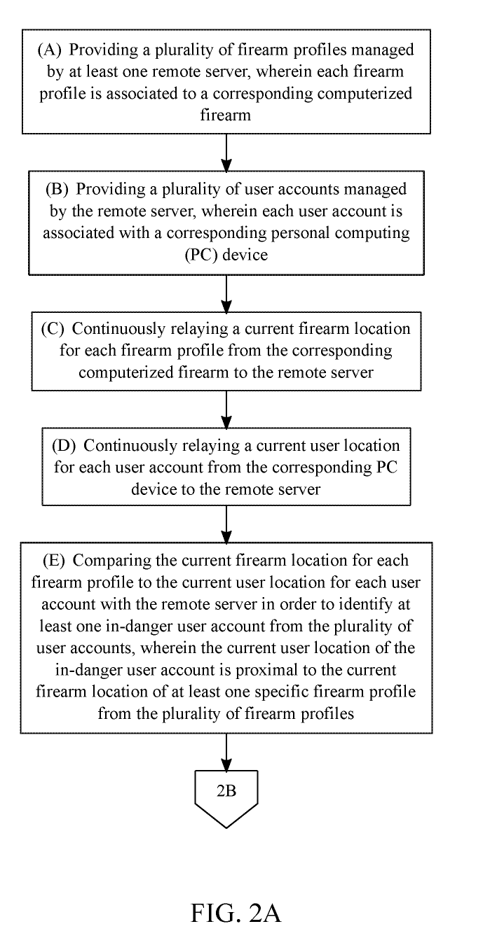

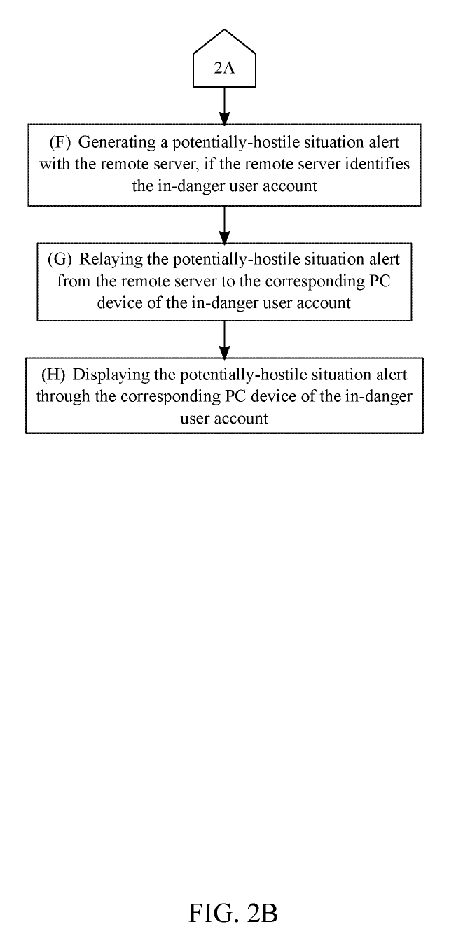

As can be seen in FIGS. 2A and 2B, the method of identifying and locating firearms follows an overall process in order to implement each of the plurality of firearm profiles, the at least one remote server, and the plurality of user accounts. For the overall process, the current firearm location for each firearm profile is continuously relayed from the corresponding computerized firearm to the remote server (Step C). This arrangement establishes the locations of all firearms with a firearm profile and organizes data into useful data tables that include geographical coordinates as well as the serial number of the firearm. The collected location and serial number data for firearms may be stored and arranged in many different forms, and servers may be programmed to organize information for subsequent use by any of several application programming interfaces (APIs), libraries, or frameworks in order to ultimately provide the user with the most practical display of information. A current user location for each user account is continuously relayed from the corresponding PC device to the remote server (Step D). This arrangement establishes the locations of all users with a user profile and organizes data into useful data tables that include geographical coordinates as well as a unique identifier for each user profile. Similar to Step C, the collected location and identifier data for users may be stored and arranged in many different forms, and servers may be programmed to organize information for subsequent use by any of several application programming interfaces (APIs), libraries, or frameworks in order to ultimately provide the user with the most practical display of information. Further information provided by each user account may include data regarding user preferences over “alert distances” or other such customizable commands relevant to determining an optimal remote server response. The current firearm location for each firearm profile is compared to the current user location for each user account with the remote server in order to identify at least one in-danger user account from the plurality of user accounts, wherein the current user location of the in-danger user account is proximal to the current firearm location of at least one specific firearm profile from the plurality of firearm profiles (Step E). The remote server identifies in-danger accounts by comparing the location data of each user account to the updating data from each of the firearm profiles based on the distance of a user profile to a firearm profile.

After the server makes this determination, a potentially-hostile situation alert is generated with the remote server, if the remote server identifies the in-danger user account (Step F). The remote server recognizes that a user account is considered to be “too close” to a firearm profile, indicating that the user of the user account is in a potentially hostile situation. This results in the potentially-hostile situation alert being relayed from the remote server to the corresponding PC device of the in-danger user account (Step G). The potentially-hostile situation alert may be modified or formatted differently to determine the best presentation of information for the most rapid transmittance of the situation to the user. The potentially-hostile situation alert is displayed through the corresponding PC device of the in-danger user account (Step H). In doing so, the user is potentially able to identify danger before an incident occurs. This is ideal for police officers, who are often in distressing situations without a lot of reliable information at their disposal.

The above arrangement provides a user's PC device with information about the proximity of firearms, thus allowing for informed decision-making in potentially dangerous situations. The corresponding computerized firearm includes a firearm body and a mobile computing device, and the mobile computing device is permanently connected to the firearm body. The firearm body is a rigid support or structure within the firearm that provides a mounting area for the mobile computing device. The mobile computing device is a set of components equipped to gather and transmit data from the firearm to a remote server. The permanent connection of the mobile computing device may be accomplished through use of adhesives, fasteners, other mechanisms, or any combinations of such mechanisms. Permanently connecting the mobile computing device to the firearm body ensures uniformity of application to various firearms. Furthermore, permanent, secure connection of the mobile computing device to the firearm body reduces, and in many cases, eliminates the risk of tampering or removal of the mobile computing device. In an exemplary embodiment, the mobile computing device is permanently connected to a frame of the firearm body. Handguns are a prime example of frame mounting, as all the components mount to the frame during assembly, making it difficult to access the mobile computing device when the mobile computing device is mounted to the frame. The corresponding computerized firearm may further include a portable power source and a mobile computing device, wherein the portable power source electrically powers the mobile computing device. This arrangement separates the portable power source from the mobile computing device, so that the portable power source can be replaced or fixed without interacting with the mobile computing device.

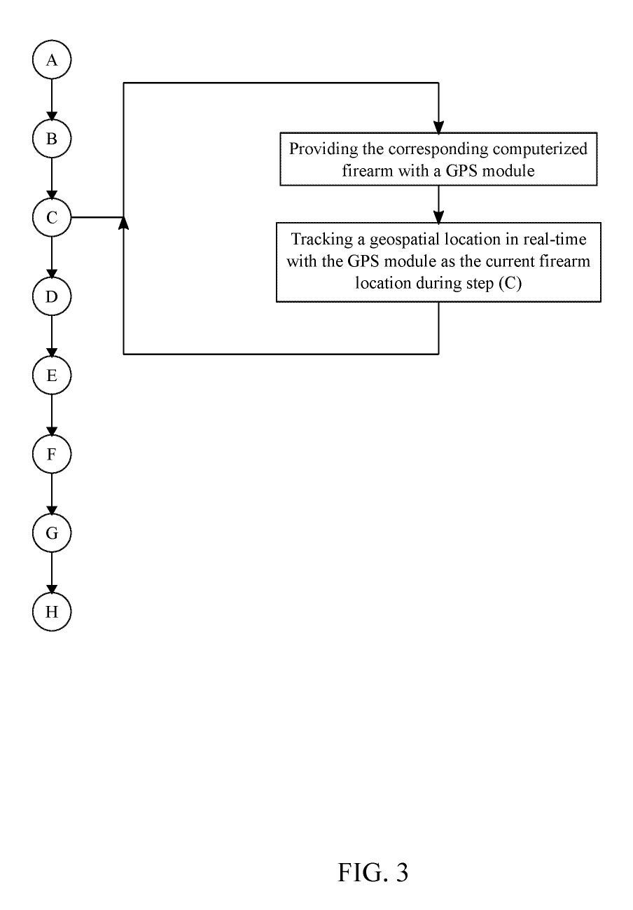

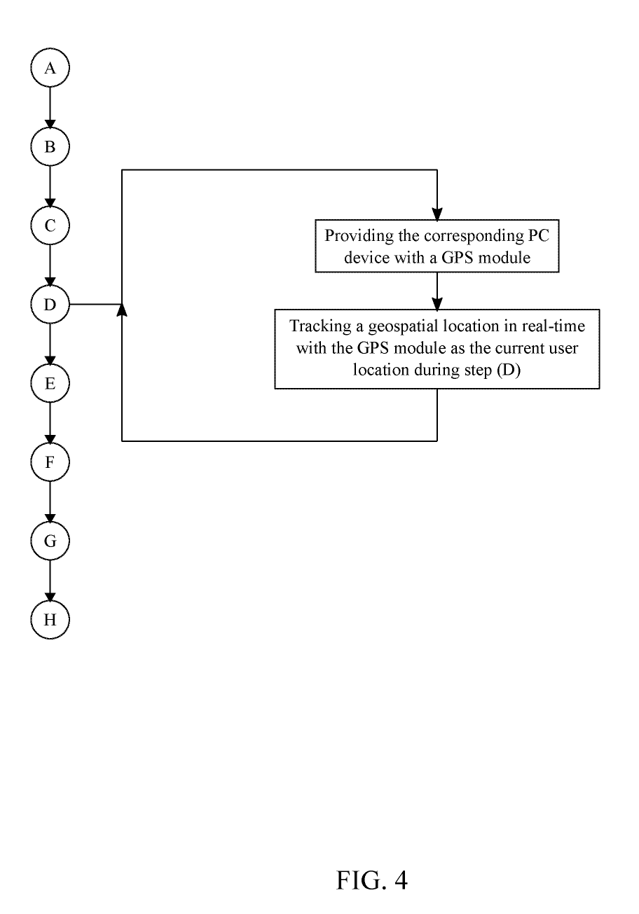

In order to determine coordinates that are useful to a computer or the remote server, the present invention must be equipped to send signals that determine the relative location of the firearm profile. To this end, the corresponding computerized firearm includes a global positioning system (GPS) module, wherein the GPS module tracks a geospatial location in real-time as the current firearm location during Step C, which is shown in FIG. 3. This arrangement allows the firearm profile to send information related to its position to the remote server. Similarly, the corresponding PC device includes a GPS module, wherein the GPS module tracks a geospatial location in real-time as the current user location during Step D, which is shown in FIG. 4. This arrangement ensures that both the firearm profile and the current user account are equipped to transmit relevant data for subsequent processing by the remote server. In addition, such an arrangement enables the user to send up-to-date information regarding their location and to receive up-to-date information about the location and proximity of firearm profiles.

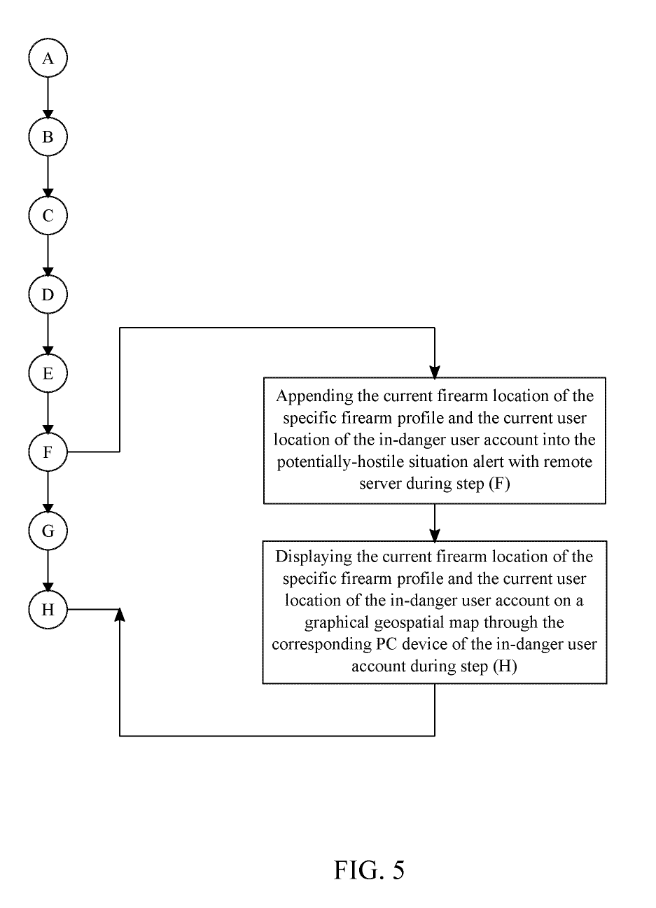

Upon accumulation of data from both the firearm profile and the user account, the remote server may be prepared to present relevant data to a user account. As can be seen in FIG. 5, the current firearm location of the specific firearm profile and the current user location of the in-danger user account is appended into the potentially-hostile situation alert with remote server during Step F. The potentially-hostile alert may be formatted or modified in order to provide information optimally before being sent. The current firearm location of the specific firearm profile and the current user location of the in-danger user account are displayed on a graphical geospatial map through the corresponding PC device of the in-danger user account during Step H. In this way, the user account receives the location of the firearm profile in a format that can be of strategic use to officers or civilians and can react accordingly.

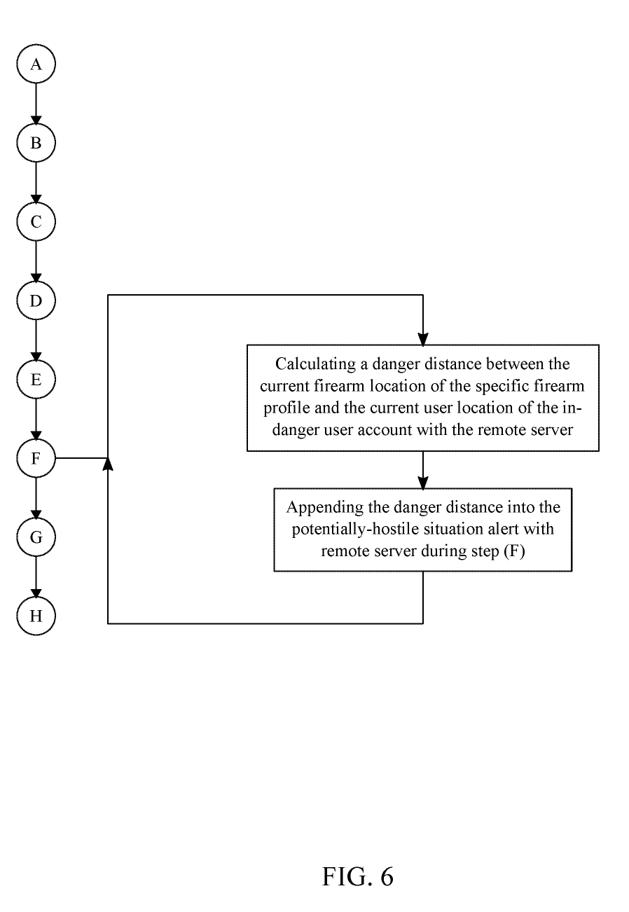

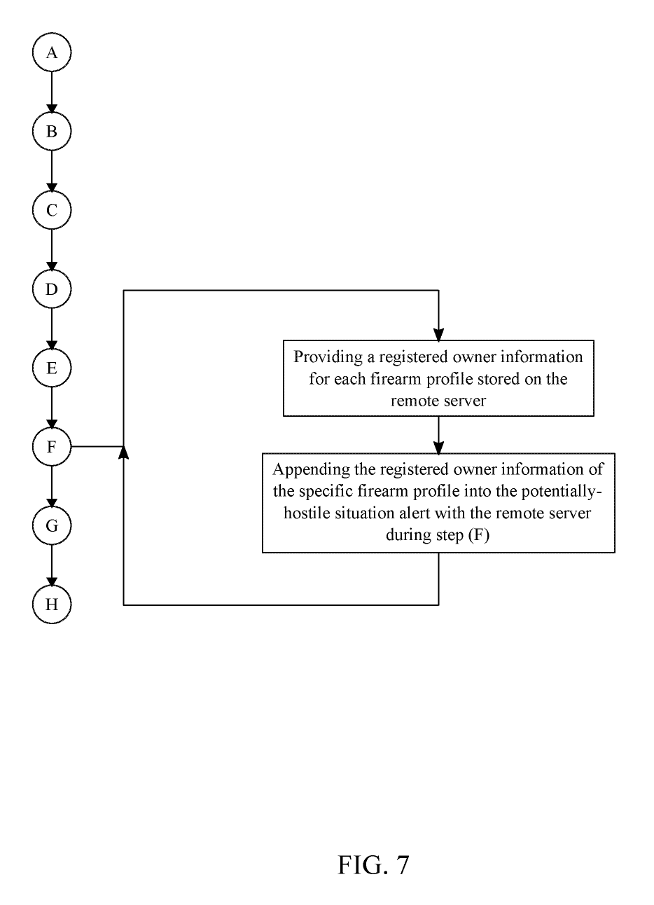

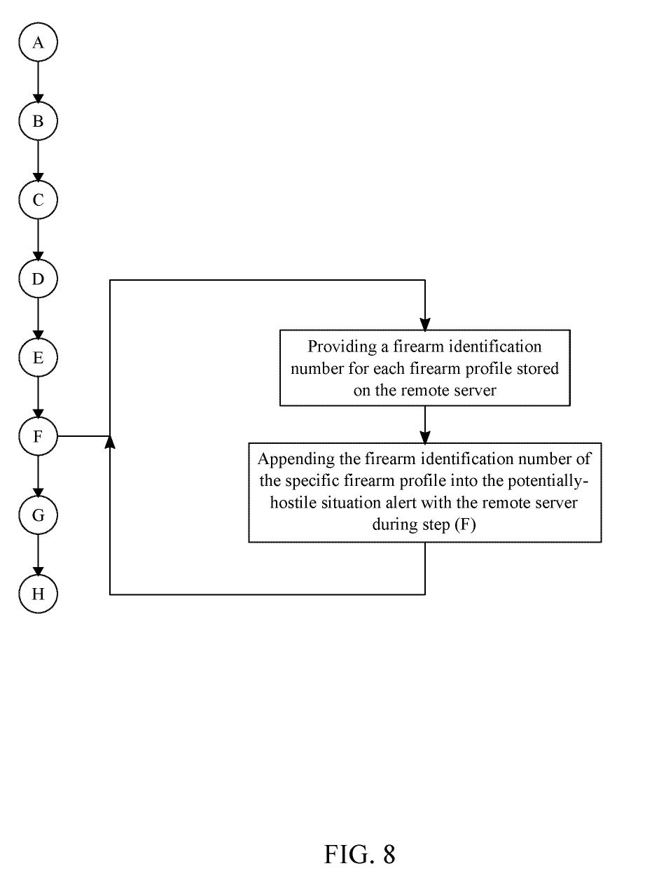

In an exemplary embodiment, the user may wish to program or set their own acceptable distance from firearm profiles. A danger distance is determined to be the physical distance between the current firearm location and the current user location of the in-danger user account. If the danger distance is less than the distance calculated by the remote server between the specific firearm profile and the current user location, the remote server sends a corresponding signal to the PC device of the user account. The danger distance is appended into the potentially-hostile situation alert with the remote server during Step F, which is shown in FIG. 6. This arrangement ensures that the user knows how far relevant firearms within the danger distance are from the user account. Moreover, the user account may further benefit from knowing the identity of the gun owner, particularly in the case of police investigating a scene at a suspect's location. To this end, registered owner information is provided for each firearm profile stored on the remote server. Subsequently, the registered owner information of the specific firearm profile is appended into the potentially-hostile situation alert with the remote server during Step F, which is shown in FIG. 7. In this way, suspect information can be collected before an altercation can occur. Further assisting in the identification of firearms is the serial code information of the firearm itself. A firearm identification number is provided for each firearm profile stored on the remote server. Subsequently, the firearm identification number of the specific firearm profile is appended into the potentially-hostile situation alert with the remote server during Step F, which is shown in FIG. 8. In this way, information about the gun, including make, model, sales records, and other such information is also made available to a user account.

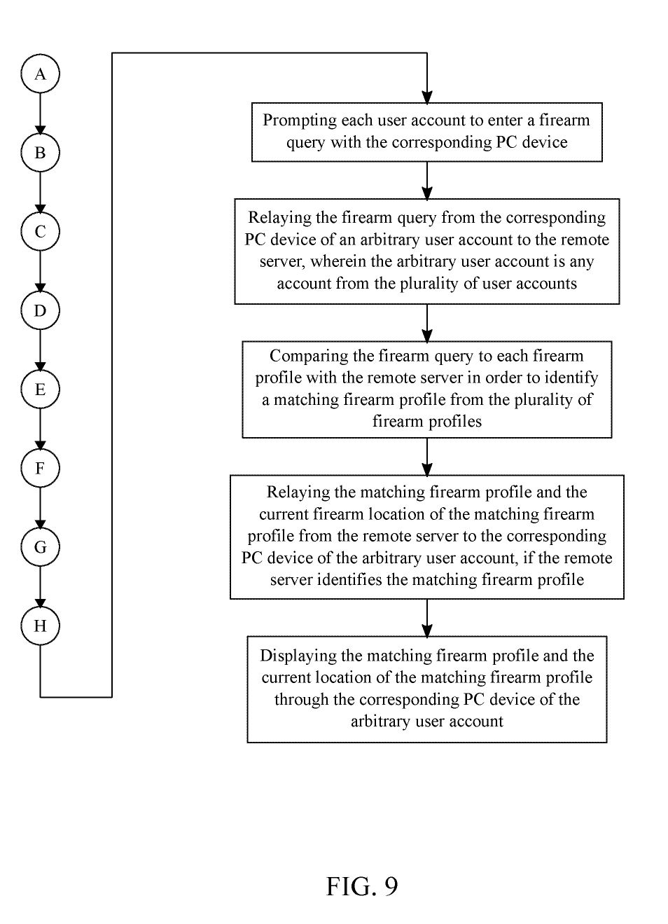

In many situations, a user may wish to manually request information about the presence or absence of firearms. As can be seen in FIG. 9, a subprocess for the method of the present invention begins by prompting each user account to enter a firearm query with the corresponding PC device. A firearm query is a request for information about nearby firearms. In this way, the user informs the PC device that the user is interested in acquiring such information about the proximity of firearms. The firearm query is relayed from the corresponding PC device of an arbitrary user account to the remote server, wherein the arbitrary user account is any account from the plurality of user accounts. The firearm query is then compared to each firearm profile with the remote server in order to identify a matching firearm profile from the plurality of firearm profiles. The matching firearm profile and the current firearm location of the matching firearm profile is relayed from the remote server to the corresponding PC device of the arbitrary user account, if the remote server identifies the matching firearm profile. This may include a multitude of different firearm profiles that are within a danger radius of the arbitrary user account. The matching firearm profile and the current location of the matching firearm profile are displayed through the corresponding PC device of the arbitrary user account. The user account can then react to the presented information appropriately.

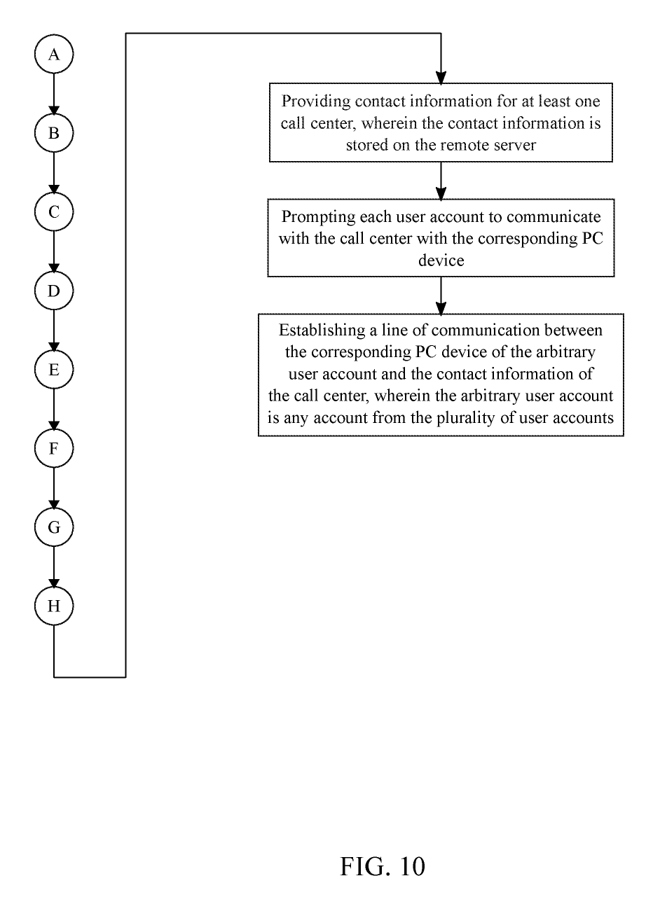

In several law-enforcement applications, it may prove more beneficial to request information from a person than to divide an officer's attention between an active crime scene and a PC. To this end, contact information for at least one call center is provided, wherein the contact information is stored on the remote server, which is shown in FIG. 10. The at least one call center is a remote location with workers who can perform a firearm query on behalf of a user account. This allows an officer to contact a call center to acquire information about a potential nearby firearm. Each user account is then prompted to communicate with the call center with the corresponding PC device. A line of communication between the corresponding PC device of the arbitrary user account and the contact information of the call center is established, wherein the arbitrary user account is any account from the plurality of user accounts. The line of communication is then used to communicate the results of the overall process as they relate to the caller.

Although the invention has been explained in relation to its preferred embodiment, it is to be understood that many other possible modifications and variations can be made without departing from the spirit and scope of the invention as hereinafter claimed.

What is claimed is:

1. A method of identifying and locating firearms, the method comprises the steps of:
(A) providing a plurality of firearm profiles managed by at least one remote server, wherein each firearm profile is associated to a corresponding computerized firearm;
(B) providing a plurality of user accounts managed by the remote server, wherein each user account is associated with a corresponding personal computing (PC) device;
(C) continuously relaying a current firearm location for each firearm profile from the corresponding computerized firearm to the remote server;
(D) continuously relaying a current user location for each user account from the corresponding PC device to the remote server;
(E) comparing the current firearm location for each firearm profile to the current user location for each user account with the remote server in order to identify at least one in-danger user account from the plurality of user accounts, wherein the current user location of the in-danger user account is proximal to the current firearm location of at least one specific firearm profile from the plurality of firearm profiles;
(F) generating a potentially-hostile situation alert with the remote server, if the remote server identifies the in-danger user account;
(G) relaying the potentially-hostile situation alert from the remote server to the corresponding PC device of the in-danger user account; and
(H) displaying the potentially-hostile situation alert through the corresponding PC device of the in-danger user account.

2. The method of identifying and locating firearms, the method as claimed in claim 1, wherein the corresponding computerized firearm includes a firearm body and a mobile computing device, and wherein the mobile computing device is permanently connected to the firearm body.

3. The method of identifying and locating firearms, the method as claimed in claim 2, wherein the mobile computing device is permanently connected to a frame of the firearm body.

4. The method of identifying and locating firearms, the method as claimed in claim 1, wherein the corresponding computerized firearm includes a portable power source and a mobile computing device, and wherein the portable power source electrically powers the mobile computing device.

5. The method of identifying and locating firearms, the method as claimed in claim 1 comprises the step of:
providing the corresponding computerized firearm with a global positioning system (GPS) module; and
tracking a geospatial location in real-time with the GPS module as the current firearm location during step (C).

6. The method of identifying and locating firearms, the method as claimed in claim 1 comprises the step of:
providing the corresponding PC device with a GPS module; and
tracking a geospatial location in real-time with the GPS module as the current user location during step (D).

7. The method of identifying and locating firearms, the method as claimed in claim 1 comprises the step of:
appending the current firearm location of the specific firearm profile and the current user location of the in-danger user account into the potentially-hostile situation alert with remote server during step (F).

8. The method of identifying and locating firearms, the method as claimed in claim 7 comprises the step of:
displaying the current firearm location of the specific firearm profile and the current user location of the in-danger user account on a graphical geospatial map through the corresponding PC device of the in-danger user account during step (H).

9. The method of identifying and locating firearms, the method as claimed in claim 1 comprises the steps of:
calculating a danger distance between the current firearm location of the specific firearm profile and the current user location of the in-danger user account with the remote server; and
appending the danger distance into the potentially-hostile situation alert with remote server during step (F).

10. The method of identifying and locating firearms, the method as claimed in claim 1 comprises the steps of:
providing a registered owner information for each firearm profile stored on the remote server; and
appending the registered owner information of the specific firearm profile into the potentially-hostile situation alert with the remote server during step (F).

11. The method of identifying and locating firearms, the method as claimed in claim 1 comprises the steps of:
providing a firearm identification number for each firearm profile stored on the remote server; and
appending the firearm identification number of the specific firearm profile into the potentially-hostile situation alert with the remote server during step (F).

12. The method of identifying and locating firearms, the method as claimed in claim 1 comprises the steps of:
prompting each user account to enter a firearm query with the corresponding PC device;
relaying the firearm query from the corresponding PC device of an arbitrary user account to the remote server, wherein the arbitrary user account is any account from the plurality of user accounts;
comparing the firearm query to each firearm profile with the remote server in order to identify a matching firearm profile from the plurality of firearm profiles;
relaying the matching firearm profile and the current firearm location of the matching firearm profile from the remote server to the corresponding PC device of the arbitrary user account, if the remote server identifies the matching firearm profile; and
displaying the matching firearm profile and the current location of the matching firearm profile through the corresponding PC device of the arbitrary user account.

13. The method of identifying and locating firearms, the method as claimed in claim 1 comprises the steps of:
providing contact information for at least one call center, wherein the contact information is stored on the remote server;
prompting each user account to communicate with the call center with the corresponding PC device; and
establishing a line of communication between the corresponding PC device of the arbitrary user account and the contact information of the call center, wherein the arbitrary user account is any account from the plurality of user accounts.
